(19) United States
(12) Patent Application Publication
(10) Pub. No.: US 2012/0166288 A1
(43) Pub. Date: Jun. 28, 2012

(54) SERVER AND SERVICE PROVIDING METHOD THEREOF

(75) Inventors: Hyung-rae CHO, Seoul (KR); Hyun-joo OH, Seoul (KR)

(73) Assignee: Samsung Electronics Co., Ltd., Suwon-si (KR)

(21) Appl. No.: 13/227,951

(22) Filed: Sep. 8, 2011

(30) Foreign Application Priority Data
Dec. 24, 2010 (KR) 10-2010-0134808

(51) Int. Cl. G06Q 30/00

(52) U.S. Cl. 705/14.66; 705/26.8

(57) ABSTRACT

A service providing method is provided. The method for providing a wishlist service of a server includes having a wishlist uploaded by a user and updating a wishlist by communicating with a service provider that provides purchase information regarding at least one item included in the wishlist.

### PRIORITY

This application claims priority to Korean Patent Application No. 2010-0134808, filed in the Korean Intellectual Property Office on Dec. 24, 2010, the entire disclosure of which is incorporated herein by reference.

### BACKGROUND OF THE INVENTION

1. Field of the Invention

The present invention generally relates to a server and a service providing method thereof, and more particularly, to a server that provides a wishlist and a service providing method thereof.

2. Description of the Related Art

A wishlist, that is, a list of goods a user wishes to purchase may be registered in a server in advance. However, such function is available only in the corresponding Internet site or Internet shopping mall.

In other words, a user may purchase goods in a wishlist only in a corresponding Internet shopping mall, and if the goods to be purchased are not specified and registered, the goods may be stored in a wishlist.

If a user registers a wishlist online, the user cannot use the wishlist when shopping in an offline shopping mall such as a department store or a discount store, and in order to purchase goods in the wishlist, the user should connect to a corresponding Internet shopping mall again or print out the wishlist.

Therefore, in order to purchase goods in the wishlist, a user may have to memorize the goods in the wishlist or write down the names of the goods and check them before purchasing the goods in a brick and mortar store.

Additionally, many services do not update information regarding goods after receiving information from a user and only push the user rather than giving recommendations after determination.

### SUMMARY OF THE INVENTION

An aspect of the illustrative embodiments relates to a server capable of updating a wishlist and a service providing method thereof.

A method for providing a wishlist service of a server, according to an embodiment of the present invention, includes having a wishlist uploaded by a user and updating the wishlist by communicating with a service provider that provides purchase information regarding at least one item included in the wishlist.

A method for providing a service in a method for providing a wishlist service of a server includes having a wishlist uploaded by a user, setting a grade of the service provider by communicating with a service provider who provides purchase information regarding at least one item included in the wishlist, and if a predetermined event occurs, providing purchase information regarding a corresponding item based on the set grade of the service provider.

A server which provides a wishlist service, according to an embodiment of the present invention, includes a communication unit in which a wishlist is uploaded by a user, a storage unit which stores the uploaded wishlist, an update unit which updates the wishlist, and a control unit which updates the wishlist by communicating with a service provider providing purchase information regarding at least one item included in the wishlist.

A server which provides a wishlist service, according to an embodiment of the present invention, includes a communication unit in which a wishlist is uploaded by a user, a storage unit which stores the uploaded wishlist, a grade-setting unit which sets a grade of the service provider by communicating with a service provider that provides purchase information regarding at least one item included in the wishlist, an information-providing unit which provides purchase information regarding the at least one item to a user, and a control unit which, if a predetermined event occurs, provides purchase information regarding a corresponding item based on the set grade of the service provider.

Accordingly, as information is provided according to each user's context, a product may be recommended effectively.

### BRIEF DESCRIPTION OF THE DRAWINGS

The above and/or other aspects of the present disclosure will be more apparent by describing certain present disclosure with reference to the accompanying drawings, in which:

FIG. 1 illustrates a service system providing a wishlist service according to an embodiment of the present invention;

FIGS. 2A to 2C illustrate configuration of a service according to various embodiments;

FIGS. 3A to 3C illustrate a method for setting a grade of service providers and a method for updating the grade according to various embodiments;

FIG. 4 illustrates a method for providing a service for each grade according to an embodiment;

FIG. 5 illustrates a flowchart regarding a wishlist service system according to an embodiment;

FIG. 6 illustrates a method for providing a service of a server according to an embodiment; and

FIG. 7 illustrates a method for providing a wishlist service of a server according to another embodiment.

### DETAILED DESCRIPTION OF EMBODIMENTS OF THE PRESENT INVENTION

Certain illustrative embodiments are described in more detail below with reference to the accompanying drawings.

In the following description, like drawing reference numerals are used for the like elements, even in different drawings. The matters defined in the description, such as detailed construction and elements, are provided to assist in a comprehensive understanding of embodiments. However, embodiments can be practiced without those specifically defined matters. Also, well-known functions or constructions are not described in detail since they would obscure the application with unnecessary detail.

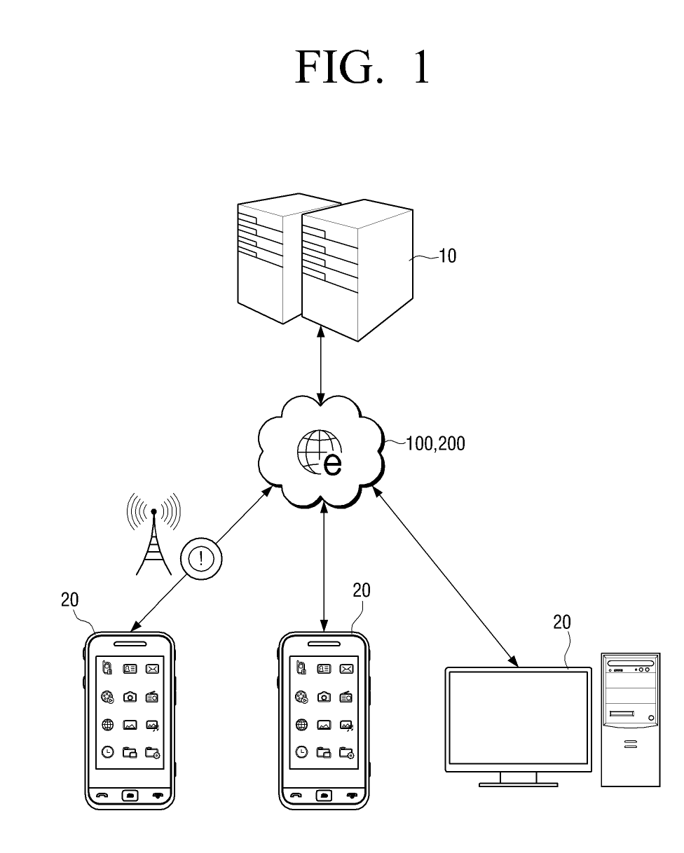

FIG. 1 illustrates a service system providing a wishlist service according to an embodiment of the present invention.

According to FIG. 1, the service system may comprise a server 100, a user terminal device 200, and a service provider 20.

The server 100 may provide a wishlist service according to an embodiment of the present invention. For example, the server 100 may be a cloud server using a cloud computing technology.

Cloud computing technology represents an Internet-based (cloud) computing technology, which is a web-based software service that stores programs in a utility data server on Internet so that a user may bring and use the programs in a computer or a mobile phone whenever necessary. The detailed description regarding cloud computing will be omitted.

First, one of user terminal devices 20 may connect to the server 100 to be provided with a wishlist service. For example, a user may connect to the server 100 via a wired terminal such as a Personal Computer (PC) or a wireless terminal such as a notebook PC or a mobile phone. Specifically, a user may create an account for the server 100 by inputting user information such as a user's name, resident registration number, contact number, identification, or password.

If user information is received from the user terminal device 20, the server 100 may store and manage information regarding buyers received and stored in a storage unit (not shown). As the user information is stored in the server 100, a user may be provided with a wishlist service from the server 100

Subsequently, a user may use a wishlist service by inputting identification information and password information to the user terminal device 100, thereby logging in to the server 100.

The service provider 10 may provide information regarding at least one item stored in a wishlist.

The service provider 10 may update a wishlist by providing information regarding at least one item stored in a wishlist by communicating with the server 100. The detailed description regarding this will be provided later.

The service provider 10 may be specifically embodied as a service-providing server. For example, the service provider 10 may be various servers providing information regarding purchasing of at least one item stored in a wishlist. For example, the service provider 10 may be a server regarding a credit card, a server regarding comparison of prices, a server regarding a shopping mall, and a server regarding real-time post-purchase evaluation.

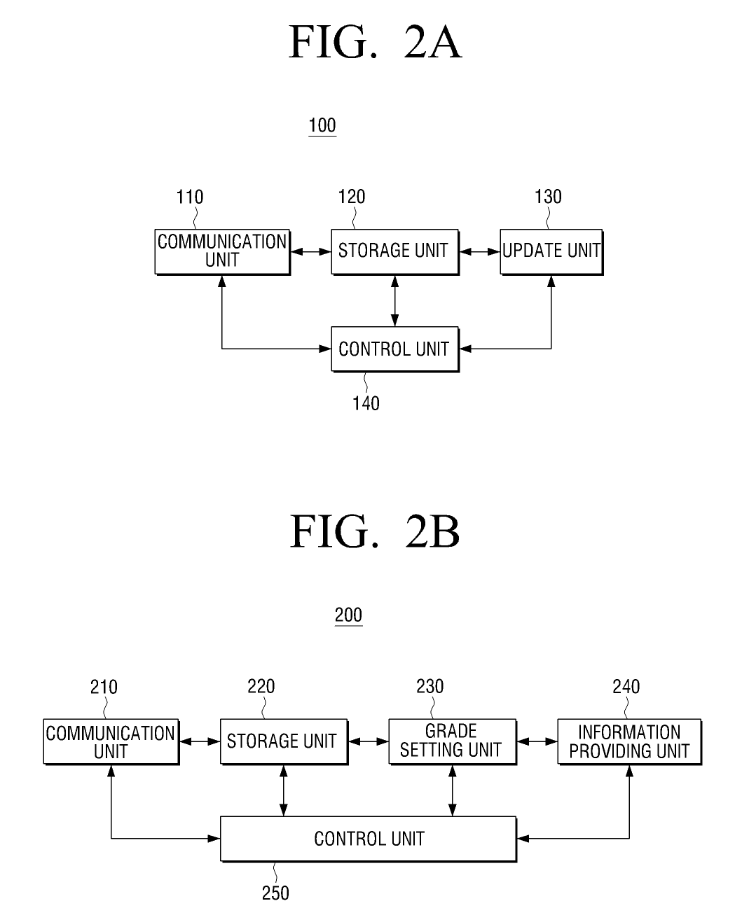

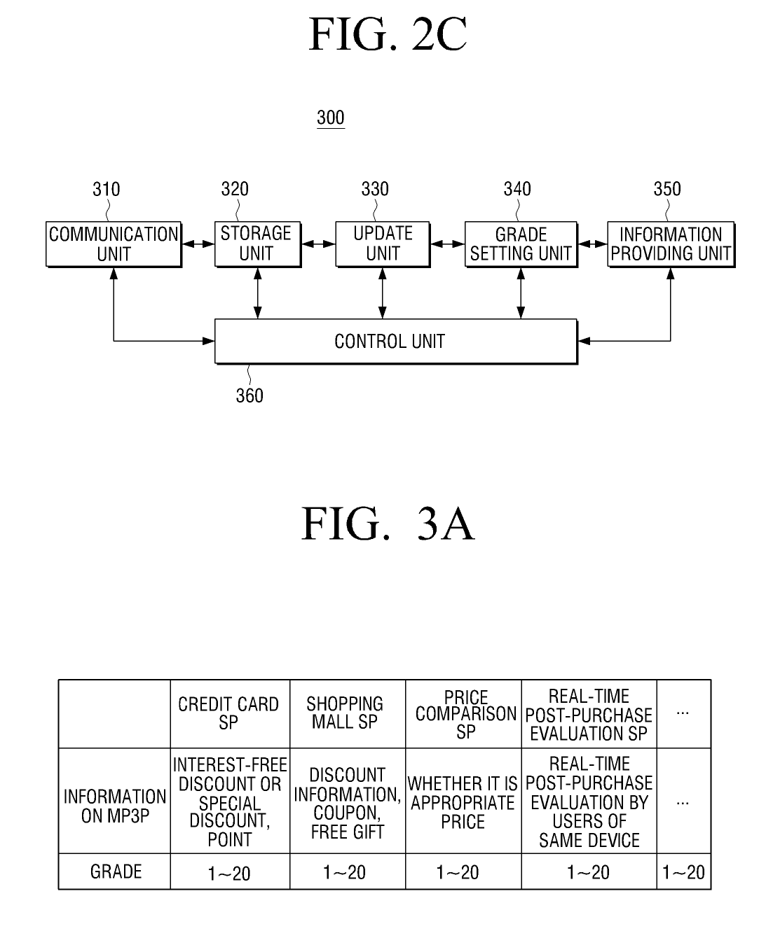

FIG. 2A is a block diagram, illustrating the configuration of a server according to an embodiment of the present invention.

According to FIG. 2A, the server 100 comprises a communication unit 110, a storage unit 120, an update unit 130 and a control unit 140.

The communication unit 110 may upload a user's wishlist. For example, the communication unit 110 may upload a wishlist by communicating with the user terminal device 20.

Additionally, the communication unit 110 may communicate with the service provider 10, which provides purchase information regarding at least one item included in a wishlist. Specifically, the communication unit 110 may communicate with the service provider 10 periodically or whenever a predetermined event occurs in order to receive information. The service provider 10 may be a server regarding at least one of a credit card, comparison of prices, a shopping mall, and real-time post-purchase evaluation.

The storage unit 120 stores a wishlist uploaded from a user and various relevant information.

The update unit 130 may update a wishlist stored in the storage unit 120.

The control unit 140 may update a wishlist by communicating with a service provider, which provides purchase information regarding at least one item included in a wishlist. Specifically, the control unit 140 may update various purchase information regarding at least one item included in a wishlist.

FIG. 2B is a block diagram illustrating the configuration of the server 200 according to another embodiment of the present invention.

According to FIG. 2B, the server 200 comprises a communication unit 210, a grade-setting unit 220, an information-providing unit 230 and a control unit 240. Among the components illustrated in FIG. 2B, those components illustrated in FIG. 2A will not be explained in detail.

The communication unit 210 uploads a wishlist from a user.

The storage unit 220 stores the uploaded wishlist.

The grade-setting unit 230 may set/change a grade of a service provider by communicating with the service provider 10, which provides purchase information regarding at least one item included in a wishlist. The service provider 10 may be a server regarding at least one of a credit card, comparison of prices, a shopping mall, and real-time post-purchase evaluation.

For example, the grade-setting unit 230 may set a grade of the service provider 10 by applying evaluation of at least one service provided by the service provider 10.

The information control unit 240 may provide purchase information regarding the at least one item to a user.

If a predetermined event occurs, the control unit 250 may provide purchase information regarding a corresponding item based on a grade set for a service provider.

For example, if a user visits a physical store which sells an item included in an updated wishlist, purchase information regarding the corresponding item may be transmitted to the user terminal device 200.

In this case, whether a user visits a brick and mortar store may be identified using a Global Positioning System (GPS) receiver in the user terminal device 20. Specifically, the user terminal device 20 may generate location information by receiving a GPS signal from a GPS satellite (not shown) and the generated location information may be transmitted to the server 100. For example, the user terminal device 20 may identify a current location by measuring the arrival time and distance of a signal from more than three GPS satellites. Additionally, a Differential GPS (DGPS) may be used to minimize an error range. Additionally, the user terminal device 100 may acquire not only latitude, longitude, and altitude but also an accurate time from a GPS signal.

FIG. 2C is a block diagram illustrating the configuration of the server 300 according to another embodiment of the present invention.

According to FIG. 2C, the server 300 comprises a communication unit 310, a storage unit 320, an update unit 330, a grade-setting unit 340, an information-providing unit 350, and a control unit 360.

The communication 310 may upload a wishlist from a user. For example, the communication unit 310 may upload a wishlist by communicating with the user terminal device 20.

Additionally, the communication unit 310 may communicate with the service provider 10, which provides purchase information regarding at least one item included in a wishlist. Specifically, the communication unit 310 may communicate with the service provider 10 periodically or whenever a predetermined event occurs in order to receive information. The service provider 10 may be a server regarding at least one of a credit card, comparison of prices, a shopping mall, and real-time post-purchase evaluation.

The storage unit 320 stores a wishlist uploaded from a user and various relevant information accordingly.

The update unit 330 may update a wishlist stored in the storage unit 320.

The grade-setting unit 340 may set a grade of the service provider 10 by communicating with a service provider, which provides purchase information regarding at least one item included in a wishlist.

The information control unit 350 may provide purchase information regarding the at least one item to a user

The control unit 360 may update a wishlist by communicating with a service provider, which provides purchase information regarding at least one item included in a wishlist.

Specifically, the control unit 360 may update a set grade based on purchase information provided by a service provider.

If a predetermined event occurs, the control unit 360 may provide purchase information regarding a corresponding item based on an updated grade of a service provider.

Additionally, the control unit 360 may determine at least one of a content of a commercial message, a time of providing a commercial message, and a method for providing a commercial message, and provide purchase information regarding a corresponding item based on the determination.

The control unit 360 may provide purchase information using at least one method including a method of transmitting a message to a mobile terminal device, a method of transmitting an e-mail to an e-mail account, and a method of transmitting information by mail, according to a set grade.

Additionally, if a user visits at least one of a brick and mortar store and a shopping site which sells the corresponding item, the control unit 360 may provide purchase information using a method for providing purchase information corresponding to a currently set grade.

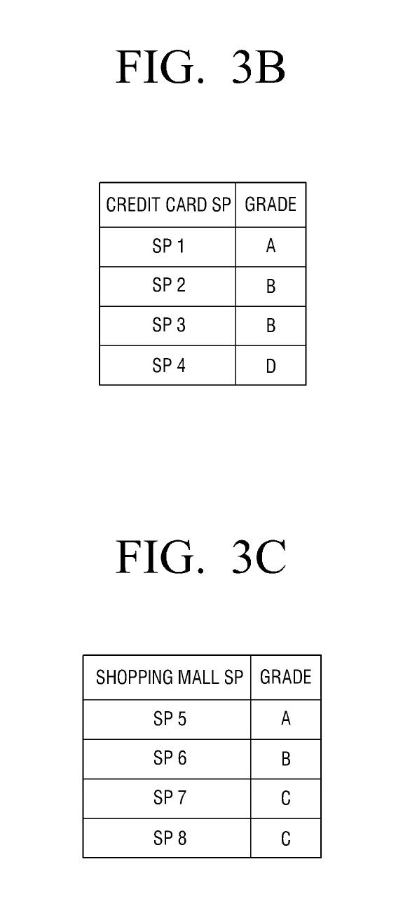

FIGS. 3A to 3C illustrate a method for setting a grade of service providers and a method for updating the grade according to various embodiments of the present invention.

According to FIG. 3A, scores may be given with regard to corresponding information for each type of service providers and a grade of each service provider may be determined by adding the scores.

For example, a grade of a service provider in a credit card-related service may be set in consideration of information such as interest-free discount information, special discount information or point reserving information. Additionally, a user's budget plan may also be considered to set a grade if such information is registered in the server 200. For example, scores may be given to interest-free discount information, special discount information, and point reserving information of “credit card company S” and a grade of “credit card company S” may be set by adding those scores. A service provider in a credit card-related service may be various credit card companies.

A grade of a service provider in a shopping mall-related service may be set in consideration of information such as discount information, a coupon and a free gift. A service provider in a shopping mall-related service may be various department stores, discount stores and Internet shopping malls.

That is, scores may be given to discount information, a coupon and a free gift of “shopping mall L” and a grade of “shopping mall L” may be set by adding the scores.

Additionally, whether an appropriate price has been charged may be considered to set a grade of service providers in a price comparison-related service. For example, whether an appropriate price has been charged in “price comparison site D” may be determined by comparing the price with a price in other price comparison sites to determine a grade of “price comparison site D”.

In the case of a service provider in a price comparison-related service, a price provided by the service provider may be used in relation to information regarding a service provider in the shopping mall-related service. That is, price information provided by a service provider in a price comparison-related service may be used to determine a grade of the shopping mall.

A service provider in a real-time post-purchase evaluation service may be various web sites, and information regarding setting a grade may include real-time post-purchase evaluation by users. For example, a grade may be given to an evaluation service regarding a corresponding item based on real-time evaluation regarding the corresponding item.

That is, the server 200 may generate an entry in a database for each product registered in a wishlist and update a grade of a corresponding service provider 20 by communicating with the service provider 20 periodically.

As described above, purchase information regarding a corresponding item may be provided to the user terminal device 100 based on an updated grade of the service provider 20. In this case, a grade of each service provider may be applied individually.

For example, if a user visits a brick and mortar store of “L shopping mall” and the grade of “L shopping mall” regarding a corresponding item is high, that is, the purchasing time and the price are appropriate, information regarding a credit card company with a high grade and information regarding post-purchase evaluation may be transmitted to the user terminal device 200 in the form of a text message.

When purchase information regarding a corresponding item is provided to a user of the user terminal device 100, a grade of each service provider may be applied organically.

For example, if a user visits an offline shopping store of “L shopping mall”, even though the grade of “L shopping mall” regarding a corresponding item is high, the purchase information regarding the corresponding item may not be provided to the user terminal device 200 if the grade of real-time post-purchase evaluation is not good.

According to FIG. 3B, the grade of each service provider may be set based on each type of the service provider.

For example, the grades of a corresponding item regarding credit card company-related service providers SP1 to SP4 may be set individually.

Additionally, the grades of a corresponding item regarding shopping mall-related service providers SP5 to SP8 may be set individually.

In the case of the above-mentioned price comparison-related service providers and the real-time post-purchase evaluation-related service providers, a grade may be set for each service provider. Alternatively, a grade regarding a shopping mall, which sells a corresponding item may be set, or a grade regarding post-purchase evaluation provided by a corresponding real-time post-purchase service site may be set.

For example, if a grade of a price comparison-related service provider is set, appropriate prices provided by a corresponding price comparison site are compared and a grade of the price comparison site may be set. In this case, appropriate prices provided by a price comparison site, which has a high grade may be notified to a user.

Alternatively, a price regarding a plurality of shopping malls provided by a corresponding price comparison site may be set as a grade of the corresponding shopping mall. Generally, as prices of each shopping mall are compared in a price comparison site, a grade may be given to the price of each shopping mall itself.

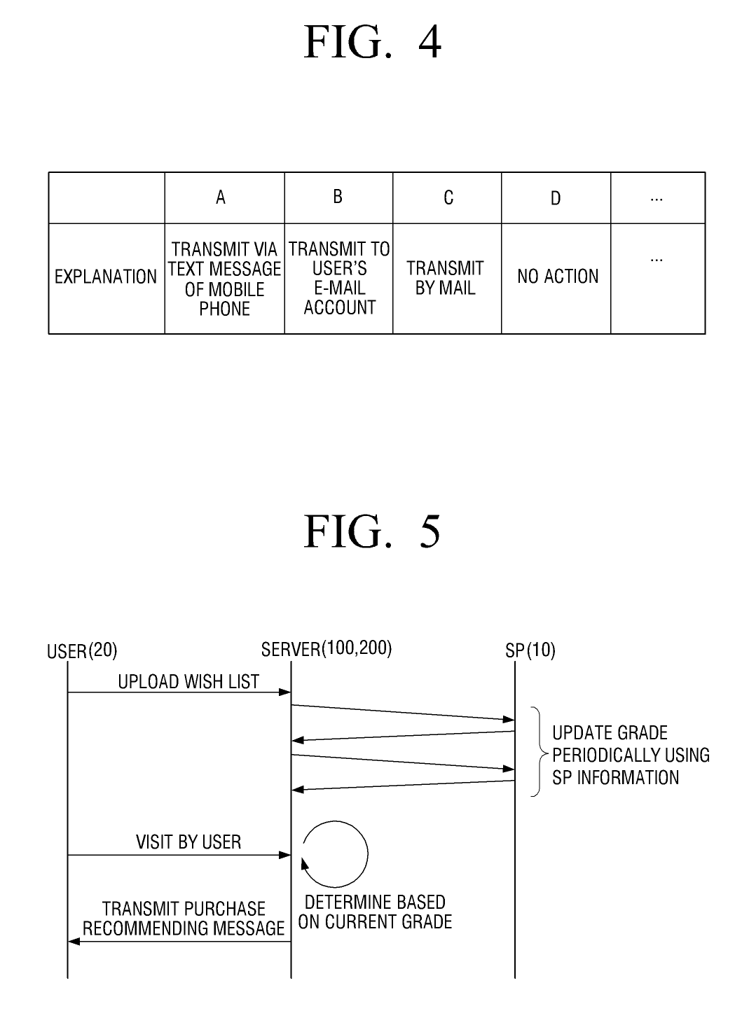

FIG. 4 illustrates a method for providing a service for each grade according to an embodiment.

According to FIG. 4, purchase information regarding a corresponding item may be provided according to a grade of each service provider.

For example, if a user visits “L shopping mall” and a purchase grade of the corresponding shopping mall regarding an item included in a wishlist is set to “A grade”, corresponding purchase information may be transmitted to a user terminal device (such as a mobile phone). The purchase information may include product name, location of store, card information, and post-purchase evaluation information.

If a user visits “L shopping mall” and a purchase grade of the corresponding shopping mall regarding an item included in a wishlist is set to “B grade”, corresponding purchase information may be transmitted to an e-mall account of the user.

If a user visits “L shopping mall” and a purchase grade of the corresponding shopping mall regarding an item included in a wishlist is set to “C grade”, corresponding purchase information may be transmitted to the user by mail.

If a user visits “L shopping mall” and a purchase grade of the corresponding shopping mall regarding an item included in a wishlist is set to “D grade”, no operation may be performed.

FIG. 5 illustrates a flowchart regarding a wishlist service system according to an embodiment.

According to FIG. 5, a user 30 uploads a wishlist regarding a desired item on a server 100, 200.

The server 100, 200 may communicate with a service provider SP 10 periodically regarding the uploaded wishlist to update a grade of the SP 10 using service providing information (SP information).

Subsequently, if the user 20 visits a predetermined brick and mortar store, a purchase recommendation message may be transmitted to the user 20 based on a grade of the SP 10. For example, if a user visits “L shopping mall” and the grade of “L shopping mall” regarding a predetermined item included in a wishlist is grade A which is to transmit a text message to a user terminal device of the user 30, a purchase recommendation message regarding the corresponding item may be transmitted to the user terminal device.

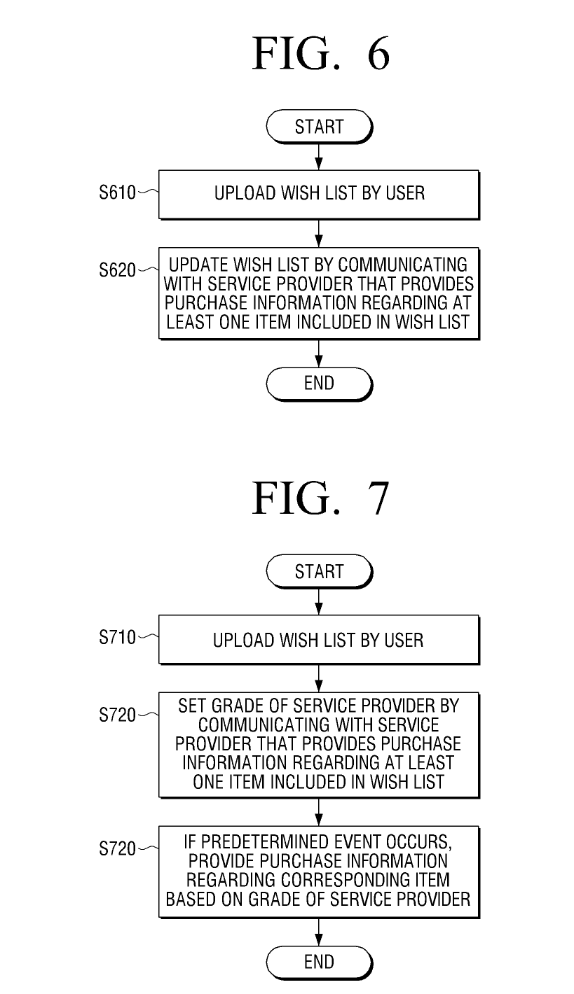

FIG. 6 is a flowchart to explain a method for providing a service of a server according to an embodiment of the present invention.

According to the method for providing a wishlist service of a server illustrated in FIG. 6, first, in step S610, a wishlist is uploaded from a user.

Subsequently, in step S620, the wishlist is uploaded by communicating with a service provider who provides purchase information regarding at least one item included in the wishlist. The service provider may be a server regarding at least one of a credit card, comparison of prices, a shopping mall, and real-time post-purchase evaluation.

If a predetermined event occurs, purchase information regarding a corresponding item may be provided to the user based on the updated wishlist.

Additionally, a grade of the service provider may be set based on purchase information regarding the at least one item provided by the service provider. The set grade may be updated periodically based on purchase information provided by the service provider.

At least one of a content of a commercial message, a time of providing a commercial message, and a method for providing a commercial message may be determined based on the set grade, and purchase information regarding a corresponding item may be provided based on the determination.

Additionally, purchase information may be provided using at least one of transmission methods including transmitting the message to a mobile terminal, an e-mail account, and by mail, based on the set grade.

If a user visits at least one of a brick and mortar store and a shopping site, which sells the corresponding item, purchase information may be provided using a purchase information providing method corresponding to a currently set grade.

FIG. 7 is a flowchart illustrating method for providing a wishlist service of a server according to another embodiment.

According to the method for providing a wishlist service of a server illustrated in FIG. 6, first, in step S710, a wishlist is uploaded from a user.

Subsequently, in step S720, a grade of the service provider is set based on purchase information regarding at least one item provided by the service provider. In this case, the service provider may be a server regarding at least one of a credit card, comparison of prices, a shopping mall, and real-time post-purchase evaluation.

Subsequently, in step S730, if a predetermined event occurs, purchase information regarding a corresponding item may be provided to the user based on the set grade of the service provider.

Additionally, the set grade may be updated periodically based on purchase information provided by a service-providing server.

At least one of a content of a commercial message, a time of providing a commercial message, and a method for providing a commercial message may be determined based on the set grade, and purchase information regarding a corresponding item may be provided based on the determination.

Additionally, purchase information may be provided using at least one of transmission methods including transmitting the message to a mobile terminal, an e-mail account, and by mail, based on the set grade.

If a user visits at least one of a physical store and a shopping site which sells the corresponding item, purchase information may be provided using a purchase information providing method corresponding to a currently set grade.

The server and the service providing method according to the embodiment as described above may be used in an e-commerce field.

As information is provided according to each user's context, a product may be recommended effectively.

Although several embodiments of the present invention have been shown and described, it would be appreciated by those skilled in the art that changes may be made in this embodiment without departing from the principles and spirit of the invention, the scope of which is defined by the claims and their equivalents.

What is claimed is:

1. A method for providing a wishlist service of a server, comprising:
uploading a wishlist by a user; and
updating the wishlist by communicating with a service provider that provides purchase information including at least one item included in the wishlist.

2. The method of claim 1, further comprising:
if a predetermined event occurs, providing purchase information regarding a corresponding item to a user based on the updated wishlist.

3. The method of claim 2, further comprising:
setting a grade of the service provider based on purchase information regarding the at least one item provided by the service provider,
wherein updating the wishlist includes updating the set grade periodically based on purchase information provided by the service provider.

4. The method of claim 3, wherein providing purchase information regarding the corresponding item comprises determining at least one of a content of a commercial message, a time of providing a commercial message, and a method for providing a commercial message according to the set grade, and providing purchase information regarding a corresponding item based on the determination.

5. The method of claim 3, wherein providing purchase information regarding the corresponding item comprises providing purchase information using at least one method including a method of transmitting a message to a mobile terminal device, a method of transmitting an e-mail to an e-mail account, and a method of transmitting information by mail, according to the set grade.

6. The method of claim 3, wherein providing purchase information regarding the corresponding item comprises, if the user visits at least one of a physical store and a shopping site which sell the corresponding item, providing purchase information using a method for providing purchase information corresponding to a currently set grade.

7. The method of claim 1, wherein the service provider is at least one of a server regarding a credit card, a server regarding comparison of prices, a server regarding a shopping mall, and a server regarding real-time post-purchase evaluation.

8. A method for providing a service in a method for providing a wishlist service of a server, the method comprising:
uploading a wishlist uploaded by a user;
setting a grade of the service provider by communicating with a service provider which provides purchase information regarding at least one item included in the wishlist; and
if a predetermined event occurs, providing purchase information regarding a corresponding item based on the set grade of the service provider.

9. The method of claim 8, further comprising:
updating the set grade periodically based on purchase information provided by the service provider.

10. The method of claim 8, wherein providing purchase information regarding the corresponding item comprises determining at least one of a content of a commercial message, a time of providing a commercial message, and a method for providing a commercial message according to the set grade, and providing purchase information regarding a corresponding item based on the determination.

11. The method of claim 8, wherein providing purchase information regarding the corresponding item comprises providing purchase information using at least one method including a method of transmitting a message to a mobile terminal device, a method of transmitting an e-mail to an e-mail account, and a method of transmitting information by mail, according to the set grade.

12. A server which provides a wishlist service, comprising:
a communication unit for uploading a wishlist by a user;
a storage unit for storing the uploaded wishlist;
an update unit for updating updates the wishlist; and
a control unit for updating the wishlist by communicating with a service provider providing purchase information regarding at least one item included in the wishlist.

13. The server of claim 12, further comprising:
an information-providing unit for providing purchase information regarding a corresponding item to a user,
wherein the control unit, if a predetermined event occurs, provides purchase information regarding a corresponding item based on the updated wishlist.

14. The server of claim 13, further comprising:
a grade-setting unit for setting a grade of the service provider based on purchase information regarding the at least one item provided by the service provider,
wherein the control unit updates the set grade periodically based on purchase information provided by the service provider.

15. The server of claim 12, wherein the control unit determines at least one of a content of a commercial message, a time of providing a commercial message, and a method for providing a commercial message according to the set grade, and provide purchase information regarding a corresponding item based on the determination.

16. The server of claim 14, wherein the control unit provides purchase information using at least one method including a method of transmitting a message to a mobile terminal device, a method of transmitting an e-mail to an e-mail account, and a method of transmitting information by mail, according to the set grade.

17. The server of claim 14, wherein the control unit, if the user visits at least one of a physical store and a shopping site which sell the corresponding item, provides purchase information using a method for providing purchase information corresponding to a currently set grade.

18. The server of claim 12, wherein the service provider is at least one of a server regarding a credit card, a server regarding comparison of prices, a server regarding a shopping mall, and a server regarding real-time post-purchase evaluation.

19. A server which provides a wishlist service, comprising:
a communication unit for uploading a wishlist by a user;
a storage unit for storing the uploaded wishlist;
a grade-setting unit for setting a grade of the service provider by communicating with a service provider that provides purchase information regarding at least one item included in the wishlist;
an information-providing unit for providing purchase information regarding the at least one item to a user; and
a control unit for, if a predetermined event occurs, providing purchase information regarding a corresponding item based on the set grade of the service provider.

20. The server of claim 19, further comprising:
an update unit for updating the set grade periodically based on purchase information provided by the service provider.

21. The server of claim 19, wherein the control unit determines at least one of a content of a commercial message, a time of providing a commercial message, and a method for providing a commercial message according to the set grade, and provide purchase information regarding a corresponding item based on the determination.

22. The server of claim 19, wherein the control unit provides purchase information using at least one method including a method of transmitting a message to a mobile terminal device, a method of transmitting an e-mail to an e-mail account, and a method of transmitting information by mail, according to the set grade.
